(19) United States
(12) Patent Application Publication
(10) Pub. No.: US 2007/0021114 A1
(43) Pub. Date: Jan. 25, 2007

(54) Distributed base station with passive antenna distribution for providing wireless communication coverage

(76) Inventors: Christopher J. Capece, Lebanon, NJ (US); Peter Giannoglou, Towaco, NJ (US); Richard T. LaGrotta, Livingston, NJ (US); Behzad D. Mottahed, Montclair, NJ (US)

Correspondence Address: CARLSON, GASKEY & OLDS, P.C., 400 W MAPLE RD, SUITE 350, BIRMINGHAM, MI, 48009, US

(21) Appl. No.: 11/186,286

(22) Filed: Jul. 21, 2005

(51) Int. Cl. H04B 1/16; H04Q 7/20

(52) U.S. Cl. 455/426.1; 455/41.2

(57) ABSTRACT

A wireless communication system (20) includes a base station (22) and remotely located radio frequency units (30, 32). A passive antenna arrangement (60) associated with each radio frequency unit conveniently and economically provides radio frequency coverage within otherwise difficult-to-reach areas. Disclosed examples include radio frequency units at various locations within a building (50) that is effectively divided into sectors served by the base station.

### FIELD OF THE INVENTION

This invention generally relates to telecommunications. More particularly, this invention relates to wireless communication systems.

### DESCRIPTION OF THE RELATED ART

Wireless communication systems are well known and in widespread use. Typical arrangements include base stations having associated antennas for transmitting and receiving signals between the base station and wireless mobile units such as cell phones. Typical base stations provide wireless communication coverage over a geographic area generally surrounding the base station. Most base stations are arranged to serve a plurality of sectors within the region or area of coverage.

One shortcoming of existing systems is that they do not consistently provide adequate coverage within buildings to allow wireless service providers to be the main provider of communication services within a building. This problem is particularly realized in buildings that are greater than fifteen stories tall because of the absence of radio frequency coverage at higher elevations.

There are circumstances where the radio frequency energy from a base station external to a building penetrates the building to provide some coverage for some individuals within some portions of a building. In most cases, however, such energy is not enough to adequately penetrate a building to provide uninterrupted wireless service throughout the building.

Several proposals have been made to improve coverage within buildings. One proposal has been to specifically direct high power radio frequency energy at a building from an external source. Although this approach is relatively simple and generally economical, there is limited control and management of the radio frequency energy. Moreover, significant interference problems tend to accompany such arrangements.

Another proposed technique has been to include radio frequency repeaters outside of a building to direct radio frequency energy at the building. A significant drawback with using such repeaters is that channel capacity from the base station macrocell, which provides the signals that are being repeated, tends to be siphoned off in a detrimental manner.

One other technique for achieving radio frequency coverage within a building includes distributing radio frequency energy within the building using many active, low power elements (sometimes referred to as nodes). This approach provides better control over the radio frequency environment but suffers from the drawback of significantly increasing equipment and installation cost. Moreover, utilizing a plurality of active, low power elements complicates maintenance issues and tends to reduce reliability.

Because each of the proposed arrangements has such drawbacks, none of them has been implemented with much success. There is a need for an economical and effective arrangement to provide wireless communication coverage within buildings or other difficult-to-reach areas. This invention addresses those needs.

### SUMMARY OF THE INVENTION

In general terms, this invention provides wireless coverage within buildings or other hard-to-reach areas using a distributed base station approach with passive radio frequency signal distribution.

An exemplary disclosed wireless communication system includes a base station for communicating with a wireless communication network. At least one radio frequency unit is located remote from the base station and is in communication with the base station. At least one passive antenna distributes radio frequency signals from the at least one radio frequency unit within a selected area near that radio frequency unit.

Such an arrangement has the advantages of extending wireless communication coverage into areas that are otherwise difficult to reach. At the same time, such an arrangement does not siphon away resources from other portions of an established communication arrangement.

In the disclosed example, each radio frequency unit that is located remote from the base station serves a sector of the corresponding base station. In one example, each radio frequency unit is dedicated to a particular portion of a building.

An exemplary disclosed method of communicating includes providing a base station for communicating with a wireless communication network. At least one radio frequency unit is located remotely from the base station. Coupling the radio frequency unit and the base station and passively distributing radio frequency signals from the at least one radio frequency unit provides wireless communication coverage within a selected area near that radio frequency unit.

One example method includes locating a plurality of radio frequency units remotely from the base station at a corresponding plurality of locations.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically shows selected portions of a wireless communication system incorporating an embodiment of this invention.

FIG. 2 shows selected portions of the embodiment of FIG. 1.

FIG. 3 schematically shows an example implementation of selected portions of the illustration of FIG. 2.

FIG. 4 schematically shows another example arrangement.

FIG. 5 schematically shows another example configuration.

FIG. 6 schematically shows an arrangement designed according to another embodiment of this invention.

### DETAILED DESCRIPTION

This invention provides a unique arrangement of base station components for providing wireless communication coverage within otherwise difficult-to-reach areas such as inside buildings. Disclosed example embodiments include a distributed base station architecture with passive distribution of radio frequency signals from the distributed components.

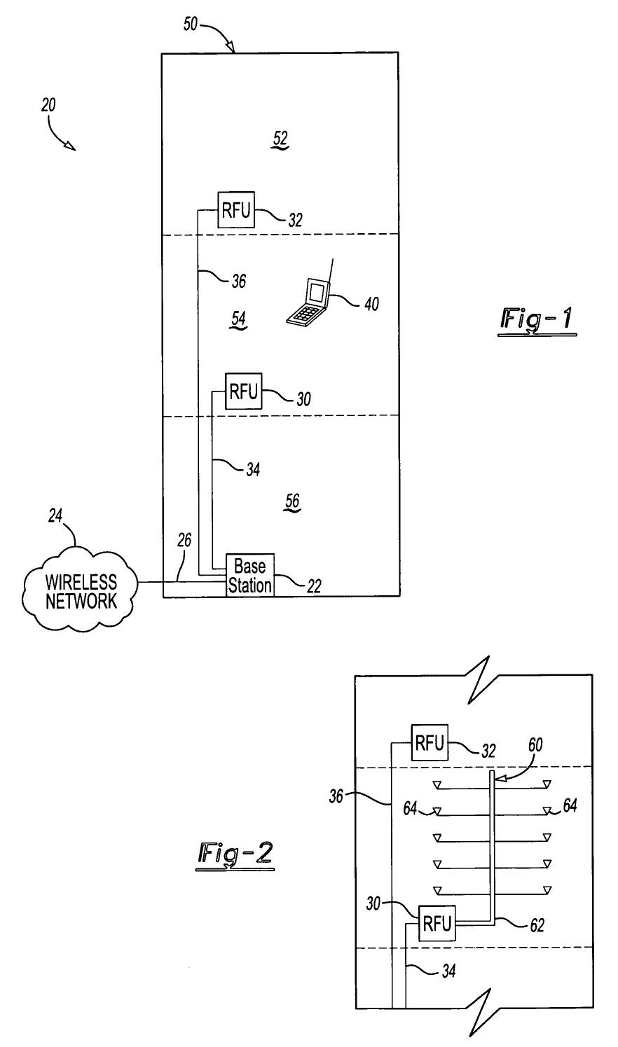

FIG. 1 schematically shows one example wireless communication system 20 including a base station 22 that operates in a generally known manner for communicating with a wireless network 24. The illustrated example includes a known connection 26 between the base station 22 and the wireless network 24. One example includes a T1 connection.

The base station 22 includes known components for communicating with the wireless network 24. The example of FIG. 1 includes at least one radio frequency unit (RFU) 30 that is remotely located from the base station 22. Another RFU 32 is located remotely from the base station 22 and remotely from the RFU 30. In this example, the RFUs 30 and 32 are connected with the base station 22 using hardwired connections 34 and 36, respectively. In one example, the connections 34 and 36 comprise known fiber connections for carrying signals between the RFUs and the base station.

Considering the RFU 30 as an example, a mobile station 40 communicates with the RFU 30 using radio frequency wireless communication signals in a known manner. The RFU 30 includes its own radio and can be considered a high power active node of the base station 22. The RFU 32 has components like those contained in the RFU 30. The components within the RFUs are known.

The example of FIG. 1 has a distributed base station architecture with the RFUs positioned at different locations to provide wireless communication coverage within selected areas. The example of FIG. 1 includes a building 50 that is effectively divided into three portions with the RFU 32 servicing a sector corresponding to a first portion 52 of the building, which comprises the uppermost floors or levels in the building 50. The RFU 30 services the second portion 54 of the building, which corresponds to a second sector serviced by the base station 22. In this example, the base station 22 includes its own radio for servicing a third sector corresponding to the third portion 56 of the building 50.

Although the example of FIG. 1 has a base station distribution arrangement that includes vertically separated sectors and vertically spaced RFU's, other example implementations includes RFU's distributed horizontally across a large building or a set of buildings, for example. The specific spatial relationship between the RFU's may vary to meet the needs of a particular situation. Those skilled in the art who have the benefit of this description will realize what will best meet their needs.

Communication signals transmitted from the RFUs 30 and 32 (and the radio of the base station 22 in this example) are distributed using a passive antenna. FIG. 2 schematically shows one example passive antenna arrangement 60. In this example, a radio frequency cable 62 carries signals from the RFU 30. A plurality of duplex antennas 64 are coupled with the cable 62 such that the antennas 64 passively radiate the signals form the RFU 30 and receive signals from mobile stations intended for the RFU 30.

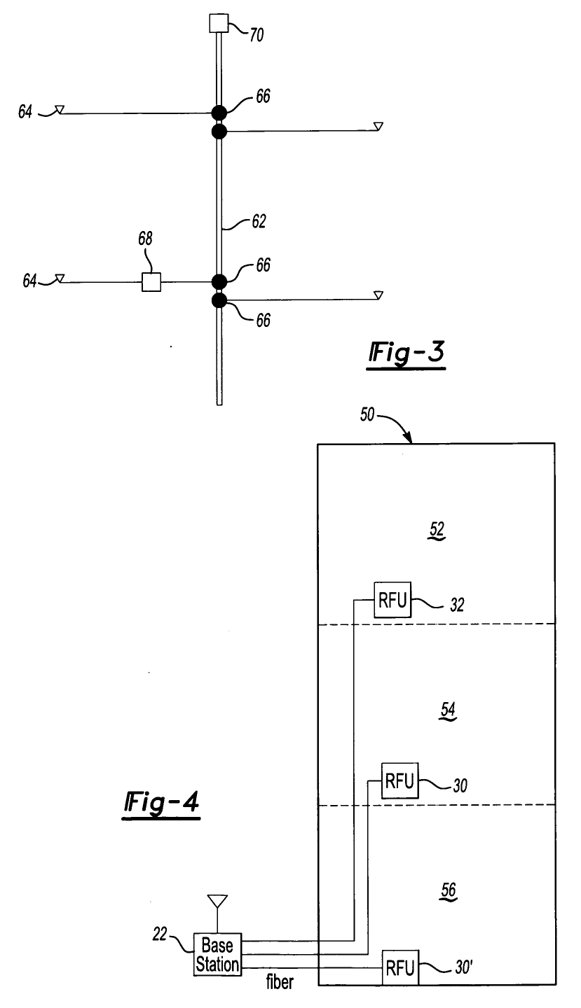

FIG. 3 schematically shows one particular arrangement where the radio frequency cable 62 includes a plurality of taps 66 for the antennas 64 to be coupled with the cable 62. In this example, the radio frequency cable 62 is a coaxial cable that can be considered the main RF cable and branch coaxial cables extend between the taps 66 and the antennas 64 so that the antennas can be strategically located within the area or sector served by the associated RFU.

The example of FIG. 3 includes at least one radio frequency attenuator 68 between a corresponding tap 66 and antenna 64 to control transmissions from the corresponding antenna as needed. The illustrated example also includes an RF termination 70 at one end of the cable 62. Known devices that introduce an appropriate load to absorb excess energy at the end of the cable 62 can be used.

In another example, the antenna assembly 60 includes a leaky coaxial cable that allows radio frequency radiation along the length of the cable such that individual antenna elements are not necessary for passively distributing RF signals from a corresponding RFU. Given this description, those skilled in the art will be able to realize an appropriate passive signal distribution arrangement to meet the needs of their particular situation.

An arrangement as schematically shown in FIG. 1 allows for carrying radio frequency energy from each RFU along the main RF cable 62 to distribute that throughout various levels within a building, for example. The system capacity is determined by the capacity at the corresponding RFU, which allows for flexibility in accommodating capacity growth in the future. For example, any adjustment in capacity or power made at the active elements (i.e., the RFUs) would automatically be driven through the passive distribution antenna arrangement 60.

A distributed base station approach as schematically shown in FIG. 1, for example, allows a base station to host one or more remote units or sectors (i.e., the RFUs) that can be installed in key locations that may otherwise be difficult to reach with wireless communication coverage. One advantage to the disclosed example is that the base station 22 is recognized by the network 24 as a single base station and no additional complexity for communications into the various sectors is introduced at the network level. Another advantage to this approach is that the base station 22 can be introduced as a new base station rather than siphoning capacity from another base station already in place as occurs with known repeater approaches.

FIG. 4 shows another example arrangement where the base station 22 is external to a building 50 and RFUs 30, 32 and 30′ are strategically positioned within the building 50 to achieve the desired level of coverage. In one example, the base station 22 is an existing, previously installed base station that is reconfigured to provide an arrangement as schematically shown in FIG. 4. In another example, the base station 22 is installed with the intention of providing coverage from the base station outside of the building 50 and providing coverage within the building using the RFUs as schematically shown.

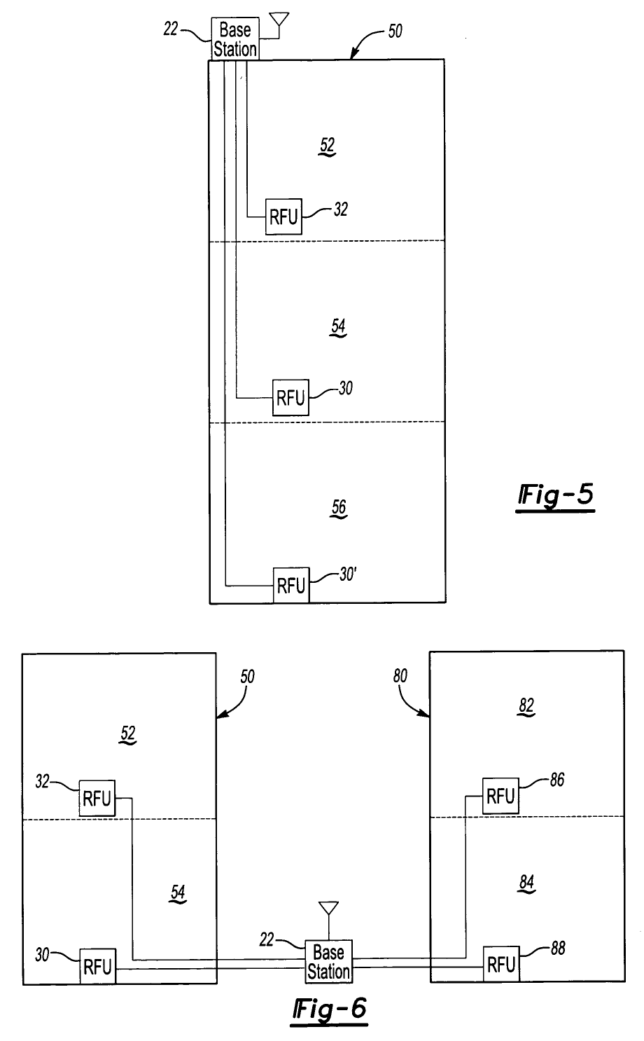

FIG. 5 schematically shows another example arrangement where a base station 22 is supported on an appropriate portion of the structure of a building 50.

FIG. 6 shows another example where a single base station 22 has RFUs distributed among different areas (in this case two different buildings). For example, RFUs 30 and 32 are positioned within a building 50 while additional RFUs provide coverage within another building 80. In this example, the building 80 is divided into two sectors 82 ands 84, which are served by RFUs 86 and 88, respectively.

As can be appreciated from the disclosed examples, a variety of system configurations are possible having a distributed base station architecture with high power active nodes strategically positioned to provide coverage as needed. Passive signal distribution using a passive antenna system at each high power active node provides wireless communication coverage within otherwise difficult-to-reach areas.

With any of the disclosed examples, the distributed base station arrangement offers the advantage of communicating with the wireless network 24 as a single, traditional, multi-sector base station. At the same time, the base station itself has a distributed architecture that achieves the goals mentioned above. The RFU for any sector can be located remotely from the base station components using fiber links as mentioned above. This allows for delivering high power radio frequency signals at appropriate locations. A small number of high power active nodes allow for distribution of radio frequency energy in a relatively simple and passive manner to achieve coverage where it otherwise was unavailable.

The disclosed examples avoid added cost and complexity associated with additional active hardware that is required by some previous proposals. Another advantage to the disclosed example is that the passive elements for distributing the radio frequency signals have excellent reliability and low failure rates such that no significant additional monitoring or servicing is introduced by taking the approach of the disclosed examples. Moreover, the passive distribution arrangement allows for locating passive components in positions that are generally inaccessible because future maintenance and monitoring is not typically going to be an issue.

Another advantage to the disclosed examples is that using a distributed base station reduces energy loss by having the RFUs located remotely at a plurality of locations instead of attempting to passively distribute all RF energy from a single point (i.e., a single antenna associated with the base station). The distribution of the RF energy with the disclosed examples occurs closer to the ultimate destinations for such signals (e.g., a mobile station within a corresponding area), which allows for using relatively higher loss cables to provide additional economic advantages regarding material cost and installation.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating, comprising:
providing a base station for communicating with a wireless communication network;
locating at least one radio frequency unit remotely from the base station;
coupling the at least one radio frequency unit with the base station; and
passively distributing radio frequency signals from the at least one radio frequency unit within a selected area near the at least one radio frequency unit.

2. The method of claim 1, comprising locating a plurality of radio frequency units remotely from the base station at a corresponding plurality of locations.

3. The method of claim 2, comprising using each of the radio frequency units for providing wireless communication coverage to a sector served by the base station.

4. The method of claim 3, comprising locating each of the radio frequency units within a different portion of a building.

5. The method of claim 1, comprising coupling at least one passive antenna with the at least one radio frequency unit.

6. The method of claim 5, comprising coupling a radio frequency cable with the at least one radio frequency unit and coupling the at least one passive antenna with the radio frequency cable.

7. The method of claim 6, comprising providing a plurality of passive antennas and coupling each of the antennas to the radio frequency cable.

8. The method of claim 5, wherein the antenna comprises a leaky coaxial cable.

9. The method of claim 5, comprising transmitting signals from the at least one radio frequency unit using the at least one passive antenna and receiving wireless signals intended for the at least one radio frequency unit using the at least one passive antenna.

10. The method of claim 1, comprising locating the at least one radio frequency unit within a building.

11. A wireless communication system, comprising:
a base station for communicating with a wireless communication network;
at least one radio frequency unit located remote from the base station and in communication with the base station; and
at least one passive antenna for distributing radio frequency signals from the at least one radio frequency unit within a selected area near the at least one radio frequency unit.

12. The system of claim 11, comprising a plurality of radio frequency units each located remotely from each other and remotely from the base station.

13. The system of claim 12, wherein each of the radio frequency units provides wireless communication coverage to a corresponding sector served by the base station.

14. The system of claim 13, wherein each of the radio frequency units is located within a different portion of at least one building.

15. The system of claim 14, wherein a first one of the radio frequency units is located within a first building and a second one of the radio frequency units is located within a second building.

16. The system of claim 1, comprising a radio frequency cable coupled with the at least one radio frequency unit and wherein the at least one passive antenna is coupled with the radio frequency cable.

17. The system of claim 16, comprising a plurality of passive antennas coupled with the radio frequency cable.

18. The system of claim 17, wherein the plurality of passive antennas are located at a corresponding plurality of locations within the area.

19. The system of claim 16, wherein the passive antenna comprises a leaky coaxial cable.

20. The system of claim 11, wherein the at least one radio frequency unit is located within a building.
